(19) United States
(12) Patent Application Publication
(10) Pub. No.: US 2026/0180157 A1
(43) Pub. Date: Jun. 25, 2026

(54) CONTEXT-AWARE CIRCUIT DESIGN FOR WEARABLE BIOSYMBIOTIC DEVICES

(71) Applicant: Arizona Board of Regents on Behalf of the University of Arizona, Tucson, AZ (US)

(72) Inventors: Philipp Gutruf, Tucson, AZ (US); Tucker Stuart, Tucson, AZ (US)

(21) Appl. No.: 19/126,967

(22) PCT Filed: Nov. 3, 2023
(86) PCT No.: PCT/US2023/036795

§ 371 Date: May 2, 2025

Related U.S. Application Data
(60) Provisional application No. 63/422,757, filed on Nov. 4, 2022.

(51) Int. Cl. H01Q 1/24; H01Q 9/04

(52) U.S. Cl. CPC H01Q 1/243; H01Q 9/0421

(57) ABSTRACT

The present disclosure provides a method for context-aware circuit design for a wearable device. The method includes determining a peak power requirement at a selected operating voltage for a rectifier circuit to be coupled between an antenna and system circuitry of the wearable device, the peak power requirement is based on a distance (d) between the wearable device and a power transmitter; determining a real value of at least on real circuit component of the rectifier circuit based on the peak power requirement; and determining a reactive value of at least one reactive component of the rectifier circuit based on the peak power requirement.

### CROSS REFERENCE TO RELATED APPLICATIONS

This application claims the benefit of U.S. Provisional Application Ser. No. 63/422,757, filed 4 Nov. 2022, which is hereby incorporated by reference in its entirety.

### TECHNICAL FIELD

The present disclosure relates to context-aware circuit design for wearable biosymbiotic devices.

### BACKGROUND

Progression towards digital medicine such as early automated diagnostics, personalized therapeutics, and individualized disease management are developments that promise to modernize the way patients are diagnosed and treated. However, progression is slow due to limitations in current wearable device systems. Conventional wearable devices exhibit several unfavorable characteristics, including poor data reliability, frequent user interaction, and battery-recharging requirements, which prohibit device application with clinically relevant fidelity and fail to promote long-term user engagement needed for realization of the digital medicine concept. Key to active disease prevention and treatment at home are wearables that enable continuous, 24/7 clinical data streams with unobtrusive hardware that is accepted by users, even in absence of immediate health issue. Development of wearable devices aimed at addressing these shortcomings have focused on implementation of soft mechanical structures and wireless power transfer (WPT), as well as energy harvesting from motion, heat and biofluids to provide skin like mechanics and eliminate the need for bulky battery supplies and user interaction, respectively.

Among these device-powering modalities, magnetic resonance coupling (MRC) is the most popular in use for wearable devices due to its established infrastructure, high power transfer efficiency and compatibility with established near-field communication protocols and enabled devices. However, operational constraints of MRC limit device function to sedentary or noncontinuous scenarios. More recently, implementation of far-field power casting has been demonstrated as a viable approach with introduction of soft materials schemes leveraging extended operational ranges of up to 2 meters. Despite its extended functional range, adoption of far-field power casting has been hindered due to poor efficiency resulting from large casting volumes, interference with surrounding materials, and spatial alignment requirements of the antenna structures. Methods such as beam-steering and deployment of antenna arrays have aimed to address these hurdles, but are limited in application due to cost, energy consumption, and large volume occupied by casting infrastructure.

To enable wearable devices that are almost imperceptible and deliver clinical-grade biosignals continuously without user burden, schemes to enable far-field power casting are critical. In current electromagnetic designs, environmental factors, distance to power casting units, worn antenna gain radiation pattern, and physiological characteristics of the intended wearer are considered. However, a critical parameter that is often neglected is human behavior and variance thereof, because information has been traditionally hard to quantify. Specifically, for far-field power casting systems, precise and statistically relevant characterization of the application scenario and full system optimization are critical to enable next generation wearables.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates and overview of behaviorally driven antenna design for continuously wearable biosymbiotic devices according to several embodiments; in addition, FIG. 1 illustrates working principles showing behavioral pattern identification and subsequent antenna design for collection of uninterrupted, high-fidelity data streams;

FIG. 2 illustrates human behavior data collection and analysis according to several embodiments; where FIG. 2a illustrates an example working principle of human behavior capture and analysis to drive antenna design; FIG. 2b illustrates example parameter extraction from 2 participants showing heat mapped location of relevant physiological markers and subsequent distribution of key parameters, namely distance from the power caster and angle offset from the power caster; FIG. 2c illustrates example distribution of distance from of the right shoulder to the power caster for individuals in an office setting (n=10) with 95% confidence interval (shaded); FIG. 2d illustrates example distribution of angle from of the right shoulder to the power caster for individuals in an office setting (n=10) with 95% confidence interval (shaded); FIG. 2e illustrates an example plot showing occupancy time of subject in the office space; FIG. 2f illustrates example plots showing percentage of time during a workday occupying office space and time spent in the office space; and FIG. 2g illustrates a graph showing the maximum power received as a function of distance by an ideal isotropic antenna under power caster illumination (3W EIRP RF power), as obtained from full-wave electromagnetic simulations;

FIG. 3 illustrates a flowchart of operations according to one embodiment;

FIG. 4 illustrates context-aware designed antenna performance according to several embodiments; where FIG. 4a illustrates an example plot showing time-dependent system load with varying sampling rates; FIG. 4b illustrates an example schematic showing Dickson circuit used for matching and rectification; FIG. 4c illustrates an example plot of real and imaginary antenna impedances for two load values at increasing distances; FIG. 4d illustrates an example rendering showing constituent layers of the personalized on-body PIFA structure; FIG. 4e illustrates an example image showing 3D printed PIFA structure, highlighting ramps and shorting strips used to connect the resonating plane to the ground plane; FIG. 4f illustrates example voltage and power curves of two antenna structures showing modulation of maximum power point of the system; FIG. 4g illustrates an example simulated and recorded values for load sweeps of the rectenna system at 0.5 m.; FIG. 4h illustrates an example simulated and recorded voltage output as a function of distance from the transmitter for the 7 kΩ load design; and FIG. 4i illustrates an example plot of simulated and recorded PIFA rectenna performance as a function of angular rotation along each x, y, and z axis in free space;

FIG. 5 illustrates 3D structure PIFA performance plots; where FIG. 5a illustrates an example simulated and recorded Z₁₁ parameters for 3D structure PIFA; FIG. 5b illustrates an example recorded and simulated data output voltage of the designed Dickson rectifier circuit; and FIG. 5c illustrates an example frequency-dependent ideal power input at the PIFA at varying distances from the power caster (Friis Equation);

FIG. 6 illustrates power distribution at 50 cm from the power casting unit; where FIG. 6a illustrates an example simulation set up; FIG. 6b illustrates an example simulated power oscillation plot with respect to system heights to the test bench; and FIG. 6c illustrates an example plot showing measured angular distribution of power recorded on a receiver antenna at 50 cm from the commercially available power casting unit (Powercast, TX91501B);

FIG. 7 illustrates a comparison of digitally designed PIFA antenna structures within various application scenarios; where FIGS. 7a-c illustrates an example load sweep comparison between simulated data (a), data recorded in an anechoic chamber (b), and data recorded in an office setting on the body (c); FIGS. 7d-f illustrates an example comparison of angularly dependent performance simulated in free space (d), measured data in an anechoic chamber (e), measured data in an office setting on the body (f); and FIGS. 7g-I illustrates an example comparison of distance dependent PIFA performance with varying loads between simulation (g), data collected in an anechoic chamber (h), and data collected in an office setting on the body (i);

FIG. 8A illustrates a flowchart of operations according to one embodiment;

FIG. 8B illustrates a flowchart of operations according to one embodiment;

FIG. 9 illustrates mechanical considerations for personalized antenna structures; where FIG. 9a illustrates an example mechanical design process that utilizes behavioral analysis and digital design to form location and mechanical optimization of personalized biosymbiotic devices; FIG. 9b illustrates an example photo of 3D printed pillar structure used to support the resonating plane from the ground plane; FIG. 9c illustrates an example plot of effective permittivity of the insulating layers as a function of 3D printed pillar density; FIG. 9d illustrates an example plot of compression force needed to collapse pillar structure with varying pillar density; FIG. 9e illustrates an example FEA of PIFA embedded into mesh design in a horizontal orientation; FIG. 9f illustrates an example FEA of PIFA embedded into mesh design in a vertical orientation; FIG. 9g illustrates an example stress versus strain curves showing effects of antenna orientation on bulk structure mechanics; and FIG. 9h illustrates an example change in power as a function of strain applied on the system for PIFA embedded in various orientations;

FIG. 10 illustrates an example fabrication process for personalized PIFA structure embedded in biosymbiotic devices; where FIG. 10a illustrates an example process flow diagram detailing fabrication of biosymbiotic devices with context-aware PIFA structures; FIG. 10b illustrates an example image of bottom elastomeric layer on FDM print bed; FIG. 10c illustrates an example image of ground plane set into bottom elastomeric layer in preparation for encapsulation and pillar structuring; and FIG. 10d illustrates an example image showing soldered C3C connections after electronics have been embedded into the system;

FIG. 11 illustrates an example pillar density modulation which includes three images of PIFA structures with varying pillar density structures;

FIG. 12 illustrates an example analysis of external forces on antenna electromagnetics; where FIG. 12a illustrates an example image of PIFA structure being compressed; and FIG. 12b illustrates an example power output as a function of pillar deformation due to PIFA compression;

FIG. 13 illustrates an example biosymbiotic device design and function that includes example illustrations of a simplified electronic circuit schematic, biosymbiotic device composition with sensor placement and characteristic performance graphs;

FIG. 14 illustrates an example design and characterization of 3D printed strain gauges; where FIG. 14 a illustrates an example rendered illustration of 3D printed strain gauge structure used for design characterization; FIG. 14b illustrates an example current versus voltage characterization graph for strain gauge devices strained from 0% to 30% displacement on custom stretching stage; and FIG. 14c illustrates an example cyclic measurements of stress and resistance for a strain gauge device loaded onto a stretching stage and stretched to 10% strain;

FIG. 15 illustrates an example temperature sensor characterization and design; where FIG. 15a illustrates an example image showing 3D printed opening and encapsulation for NTC used for collection of axilla temperature; and FIG. 15b illustrates an example characteristic graph showing voltage response of the analog circuit to increase in temperature across physiologically relevant range;

FIG. 16 illustrates an example localized relative humidity sensor characterization and design; where FIG. 16a illustrates an example image of the relative humidity sensor module embedded into the mesh devices; and FIG. 16b illustrates an example characterization plot showing voltage response to changed in relative humidity;

FIG. 17 illustrates an example long-term system demonstration and performance; where FIG. 17 a illustrates an example data collected from 14-day experiment showing collection of sampling rate (top graph), battery voltage (middle graph), temperature, humidity, strain, and corresponding continuous wavelet transform; FIG. 17b illustrates an example image of device operation in an office setting; FIG. 17 c illustrates an example plot of 4 hours of data collected during office occupancy, showing passive battery recharge over time with continuously collection of temperature, humidity, and strain; FIG. 17d illustrates an example image of device operation during exercise in a gym setting; and FIG. 17e illustrates an example plot of 2 hours of collected data during gym exercise showing temperature, humidity, and strain with corresponding continuous wavelet transform of 3D printed strain gauge data; and

FIG. 18 illustrates an example biosymbiotic electronics with different clothing types; where FIG. 18a illustrates an example image of a biosymbiotic device used during normal activity in day wear; FIG. 18b illustrates an example image of biosymbiotic device used during activity with active wear; and FIG. 18c illustrates an example image of biosymbiotic device used with buttoned shirt.

Although the following Detailed Description will proceed with reference being made to illustrative embodiments, many alternatives, modifications and variations thereof will be apparent to those skilled in the art.

### DETAILED DESCRIPTION

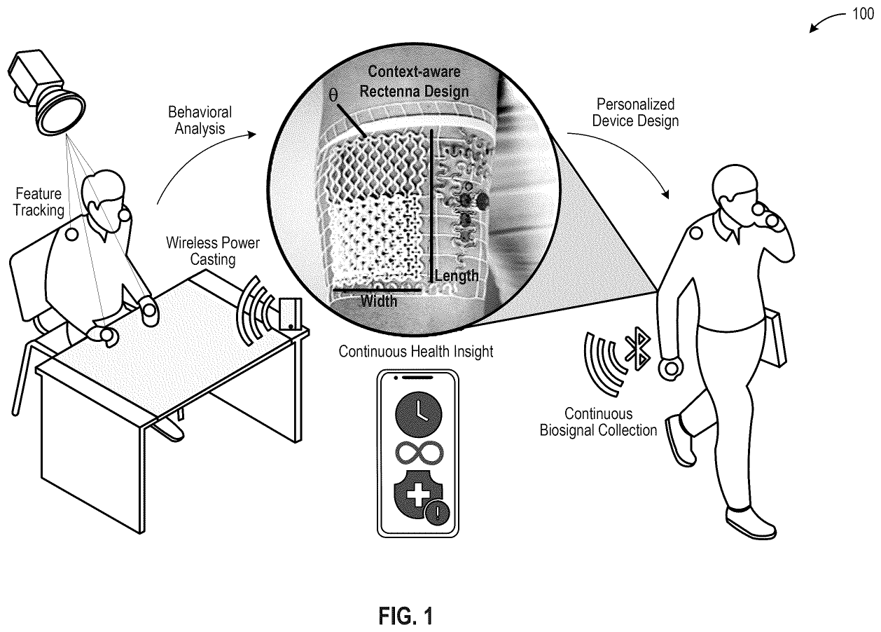

The present disclosure provides systems and methods to utilize behavioral analysis for optimized antenna and rectifier designs. FIG. 1 illustrates and overview of behaviorally driven antenna design for continuously wearable biosymbiotic devices according to several embodiments; in addition, FIG. 1 illustrates working principles showing behavioral pattern identification and subsequent antenna design for collection of uninterrupted, high-fidelity data streams. The approaches described herein facilitate optimized wireless powering solutions with tailored mechanics to realize personalized wearables for long-term collection of high-fidelity biosignals, as generally illustrated in FIG. 1. To achieve this, in some embodiments the present disclosure utilizes deep neural net analysis of a cohort of subjects in application scenarios, such as office work with an active lifestyle, which can be analyzed to extract characteristic parameters such as orientation, distance and spatial location to the power casting devices with statistical significance. These parameters may be used in determining electromagnetic characteristics of antennas and rectifiers to create context-aware circuit designs that tune key parameters, such as impedance of these components to achieve optimum system performance. This information, paired with digital manufacturing techniques, enables creation of personalized rectennas that are realized through fusion deposition modeling (FDM) printing according to the specifications obtained from behavioral observations. This concept improves far-field power casting for wearable sensing devices, allowing robust device operation without the need for large energy storage or restrictions to user mobility. The system design process enables deployment of wearable sensor systems that can collect uninterrupted steams of high-fidelity biosignals over multiple weeks without the need for user interaction. This can be achieved through powering using consistent wireless energy influx, which theoretically enables years of use without user hardware interaction.

### Human Behavioral Studies

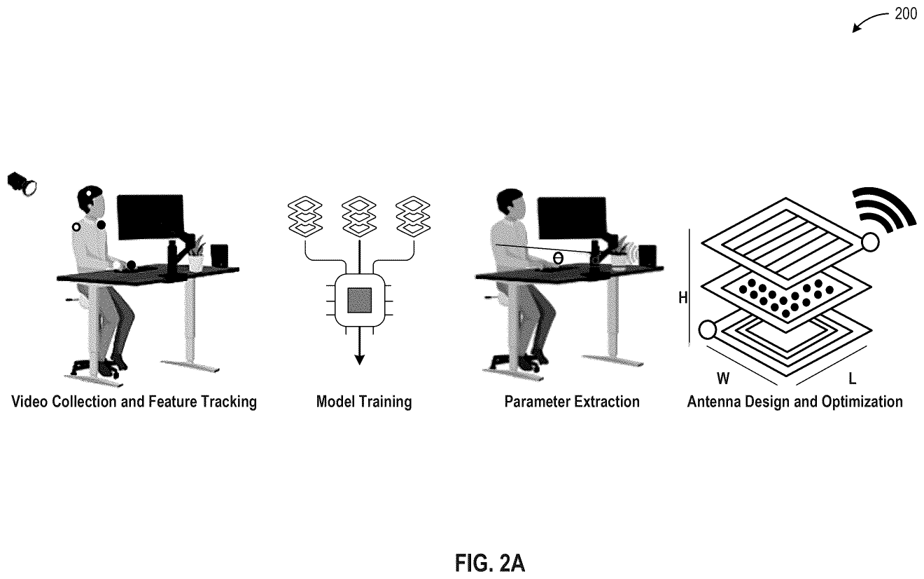

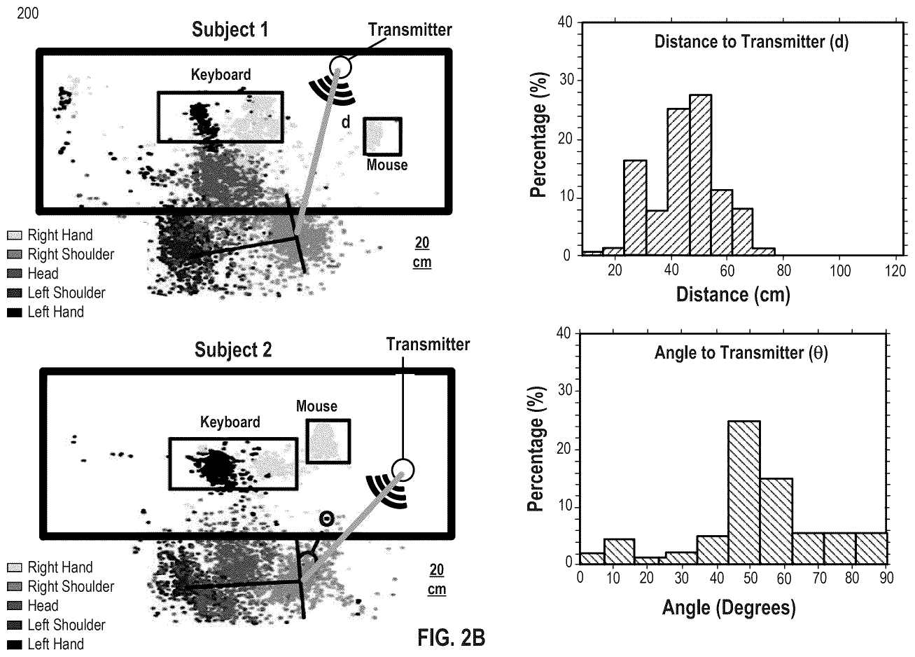

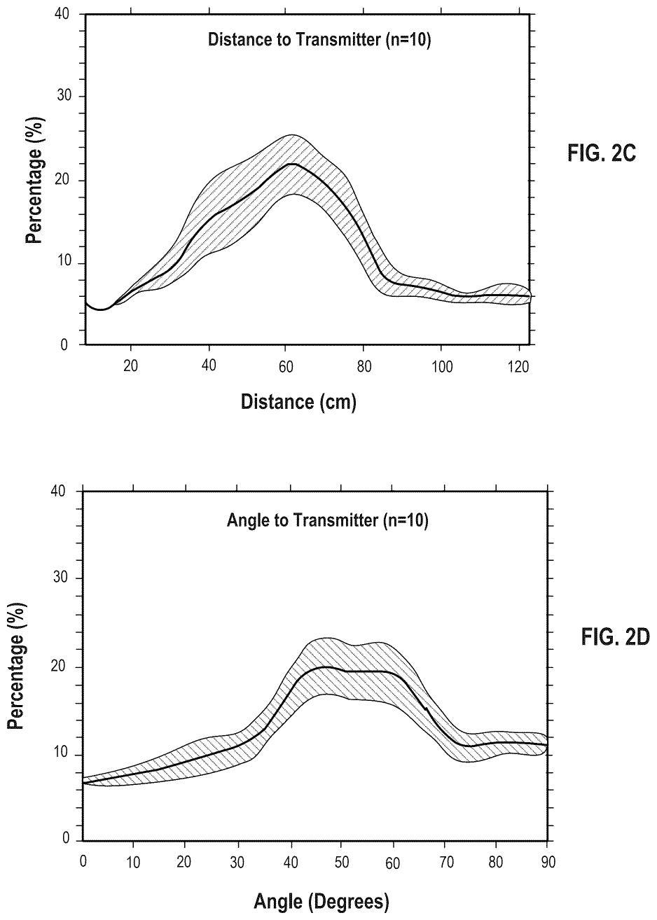

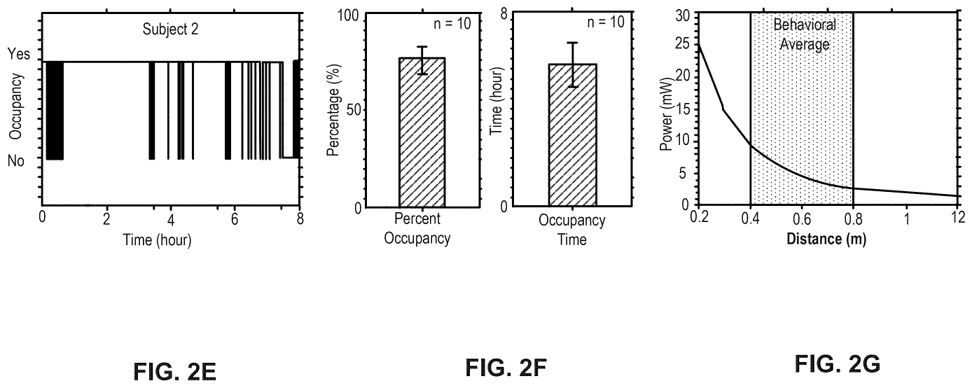

FIG. 2 illustrates human behavior data collection and analysis according to several embodiments; where FIG. 2a illustrates an example working principle of human behavior capture and analysis to drive antenna design; FIG. 2 b illustrates example parameter extraction from 2 participants showing heat mapped location of relevant physiological markers and subsequent distribution of key parameters, namely distance from the power caster and angle offset from the power caster; FIG. 2c illustrates example distribution of distance from of the right shoulder to the power caster for individuals in an office setting (n=10) with 95% confidence interval (shaded); FIG. 2d illustrates example distribution of angle from of the right shoulder to the power caster for individuals in an office setting (n=10) with 95% confidence interval (shaded); FIG. 2e illustrates an example plot showing occupancy time of subject in the office space; FIG. 2f illustrates example plots showing percentage of time during a workday occupying office space and time spent in the office space; and FIG. 2g illustrates a graph showing the maximum power received as a function of distance by an ideal isotropic antenna under power caster illumination (3W EIRP RF power), as obtained from full-wave electromagnetic simulations.

Human behavioral patterns can be exploited in rectenna (rectifier+antenna) design to optimize average power casting efficiency by tailoring to most statistically relevant scenarios of use. Deep neural net enabled video analysis typically used in neuroscience research can be employed to capture a large majority of the modern workforce behavior, which includes prolonged hours of desk work, offering settings with potential to cast energy to power wearable sensing devices. The process to acquire behavior from a cohort of test subjects (for example, n=10) is described schematically in FIG. 2a and begins with video collection of subject activity. Relevant physiological features, including the head, shoulders, and hands are labeled manually to train a deep neural network model, enabling feature extraction as described below in the Example Methods section.

Resulting location heatmaps of head, shoulders, and hands are shown for two subjects in FIG. 2b and represent 8 hours of office work. Prior to data collection, participants are instructed to position the power caster and given a brief information on its function. A dummy wearable is placed on the right, proximal region of the arm of the participants. After collection, characteristics such as distance to the power caster and angular offset are subsequently computed (see Example Methods section). Resulting data for the cohort, shown in FIGS. 2c and 2d, represent insight for localization parameters relevant for rectenna design. FIG. 2c shows the average of wearable to power casting system distance with a 95% confidence interval (shaded). An average distance of 60.13 cm with a standard deviation of 20.30 cm is computed. This distribution is skewed towards shorter distance, showing a median value of 55.38 cm. FIG. 2d shows the average distribution of the orientation angle of the wearable to the power caster with an average of 54.09 degrees and a standard deviation of 26.73 degrees (shaded confidence interval).

For an office worker, a prolonged period of stationary behavior (86.4%) is recorded in literature. In an example cohort, subject occupancy during the 8-hour experiments is defined as time spent within 150 cm of the transmitter. FIG. 2e demonstrates this feature extraction for one participant, with data indicating 7.12 hours spent within 150 cm of the transmitter, which accounts for 89.9% stationary time during the experiment. Across the cohort, an average of 72.68% of the day spent in the test location (standard deviation=10.57%) and average occupancy time of 5.81 hours (standard deviation =0.84 hours) is recorded (see FIG. 2f). Domain occupancy, when paired with spatial location information, provides the fundamental framework for optimizing rectenna design for optimized energy harvesting.

A realistic estimation of power transfer to the device is shown in FIG. 2g for an ideal isotropic (0 dBi gain) antenna receiver as a function of distance to the power casting transmitter (see Example Methods). The complex field behavior in the radiating near-field region of the transmitter cannot be adequately approximated using the classical Friis equation, which is only valid in the far-field. Therefore, the near field power density distribution of a transmitter antenna with 3W EIRP and a similar size as the power caster is obtained from full-wave simulations (see Example Methods). For the average distance of 60.13 cm obtained by the behavioral analysis, a power of 4.59 mW could be harvested as estimated under ideal conditions. To provide the best possible rectenna and wearable system design, the scenario specific information can be used to create hardware optimized to match the statistical average user, which is accomplished by matching antenna, rectifier, and load impedance.

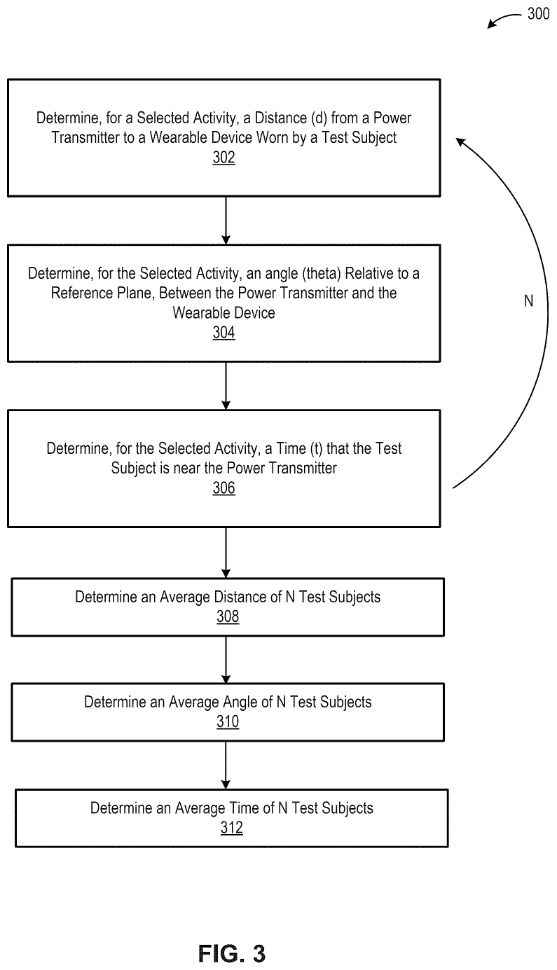

FIG. 3 illustrates a flowchart 300 of example operations according to one embodiment. In particular, the flowchart 300 of FIG. 3 illustrates example operations to determine an average distance, d, between a wearable device and a power transmitter, an average angle, theta, between the wearable device and a power transmitter with respect to a reference plane, and an average time, t, that the wearable device and the power transmitter are near each other. Operations of this embodiment include determining, for a selected activity, a distance (d) from a power transmitter to a wearable device worn by a test subject 302. Operations of this embodiment also include determining, for the selected activity, an angle (theta) relative to a reference plane, between the power transmitter and the wearable device 304. Operations also include determining, for the selected activity, a time (t) that the test subject is near the power transmitter 306. Operations also include determining an average distance of N test subjects 308. Operations also include determining an average angle of N test subjects 310. Operations also include determining an average time of N test subjects 312.

### Context-aware Rectenna Design

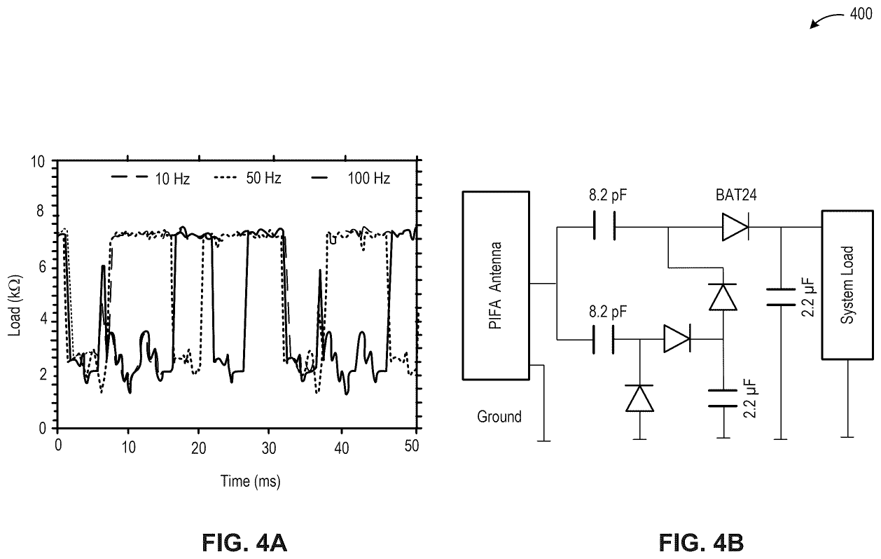

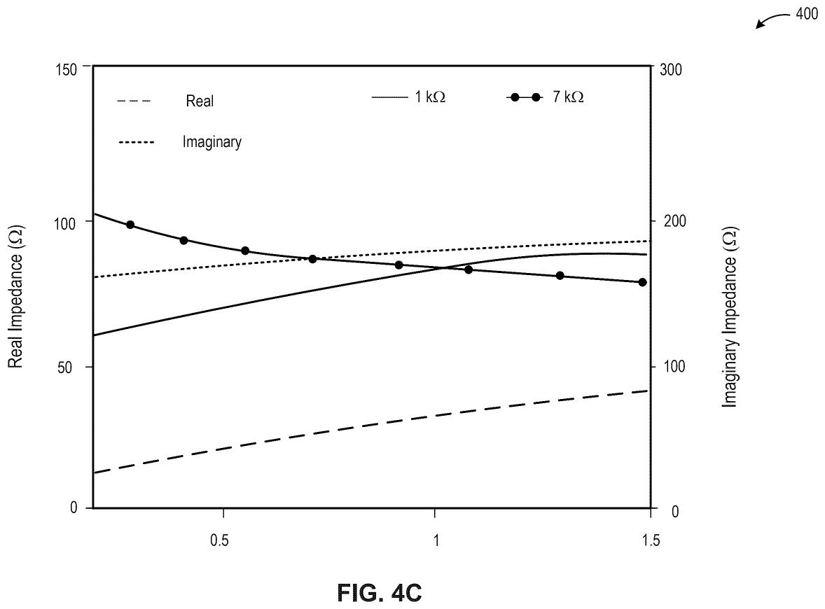

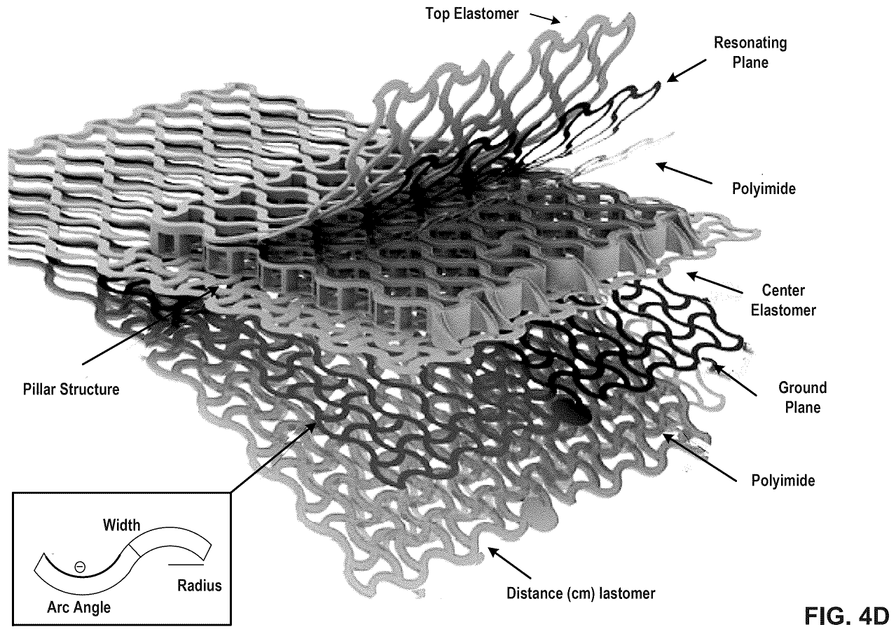

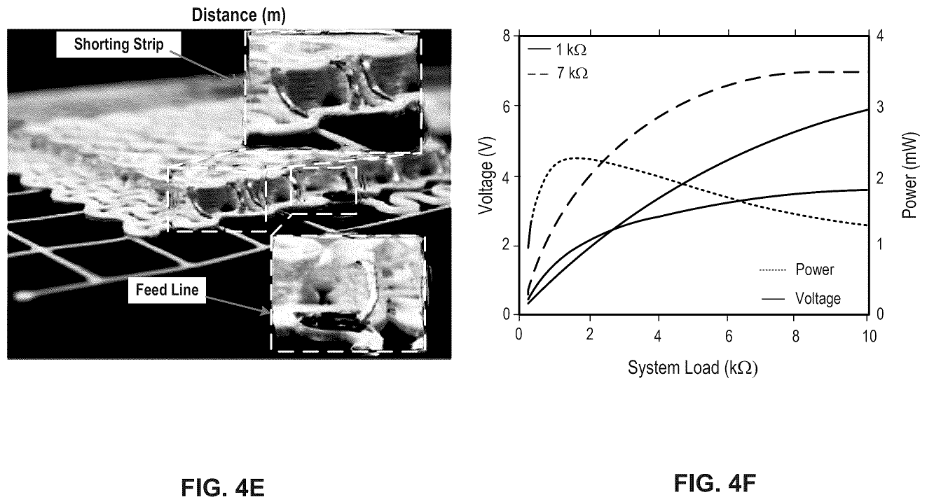

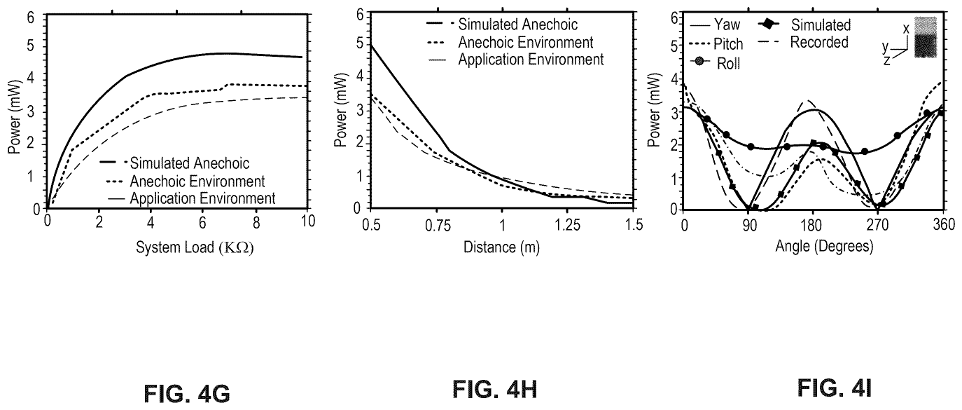

FIG. 4 illustrates context-aware designed antenna performance according to several embodiments; where FIG. 4a illustrates an example plot showing time-dependent system load with varying sampling rates; FIG. 4b illustrates an example schematic showing Dickson circuit used for matching and rectification; FIG. 4c illustrates an example plot of real and imaginary antenna impedances for two load values at increasing distances; FIG. 4d illustrates an example rendering showing constituent layers of the personalized on-body PIFA structure; FIG. 4e illustrates an example image showing 3D printed PIFA structure, highlighting ramps and shorting strips used to connect the resonating plane to the ground plane; FIG. 4f illustrates example voltage and power curves of two antenna structures showing modulation of maximum power point of the system; FIG. 4g illustrates an example simulated and recorded values for load sweeps of the rectenna system at 0.5 m.; FIG. 4h illustrates an example simulated and recorded voltage output as a function of distance from the transmitter for the 7 kΩ load design; and FIG. 4i illustrates an example plot of simulated and recorded PIFA rectenna performance as a function of angular rotation along each x, y, and z axis in free space.

To make use of design considerations extracted from behavioral data, system level requirements for energy consumption, operational voltage and peak current requirements must also be considered. FIG. 4a shows an example of transient power requirements for a biosymbiotic wearable device that features a Bluetooth Low-Energy (BLE) system on a chip (SoC) and a variety of biosensors. Using increasing polling intervals for the sensors, power requirements can vary substantially, resulting in an equivalent system load of 1-7 kΩ. Because devices include a small energy storage (either small battery or supercapacitor), average load is determined by sensor configuration and polling intervals for the biomedical application. Pairing this information with behavioral information, power casting systems can be optimized to deliver optimal power. For the wearable configuration used in these examples, a two-stage Dickson rectifier circuit is adopted (as shown in FIG. 4b) based on the operational parameters illustrated in FIG. 4a. To maximize WPT from the power caster to the rectifier circuit, complex conjugate matching is required between the antenna and the rectifier circuit. Input impedance of the rectifier circuit in its common operation modes (1 kΩ and 7 kΩ) is used to design the antenna. The input impedance of the rectifier circuit significantly depends on: 1) the available distance-dependent RF power level (shown in FIGS. 2g), 2) the system load (shown in FIG. 4a), and 3) the diode specifications (in this example, the diodes include BAT24-02LS by Infineon). The simulated input impedances of the rectifier circuit for the two extreme loading cases are compared in FIG. 4c, which shows real and imaginary part of the rectifier impedance as a function of distance from the transmitter. From 0 to 1.5 m the rectifier impedance changes steadily for both loads of 1 kΩ and 7 kΩ. The antenna can only be optimized to match a particular rectifier circuit input impedance, therefore impedance is matched for power transfer efficiency over the distance range acquired from behavioral analysis.

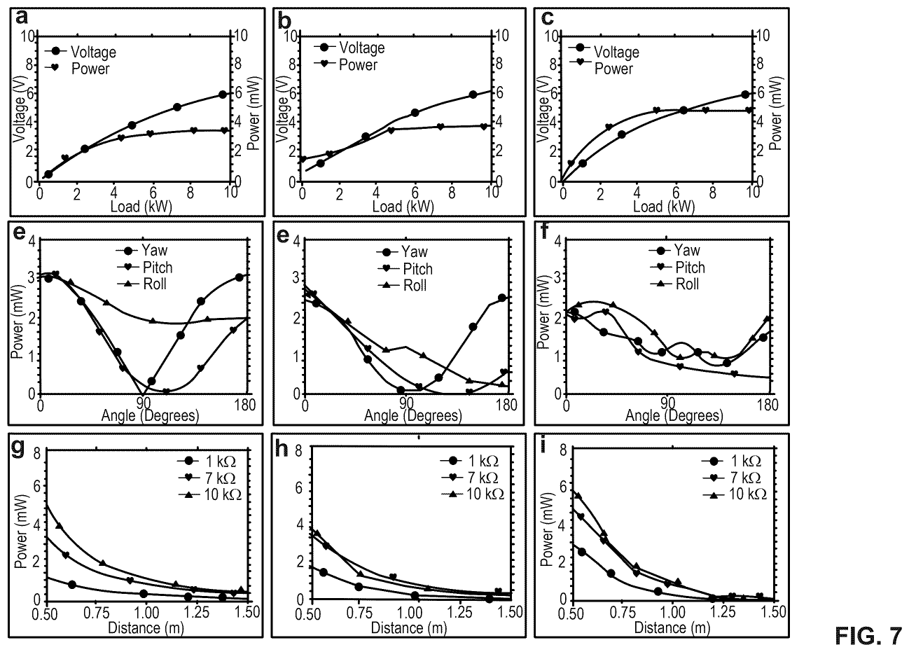

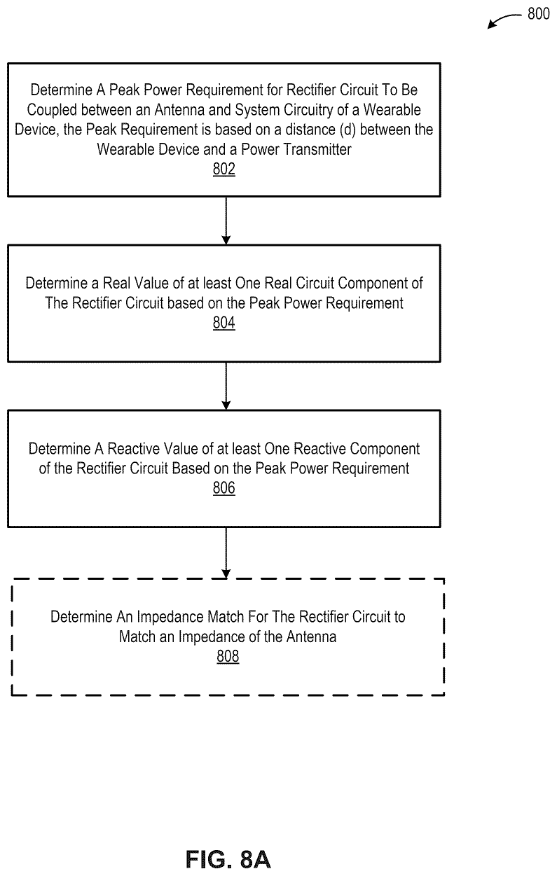

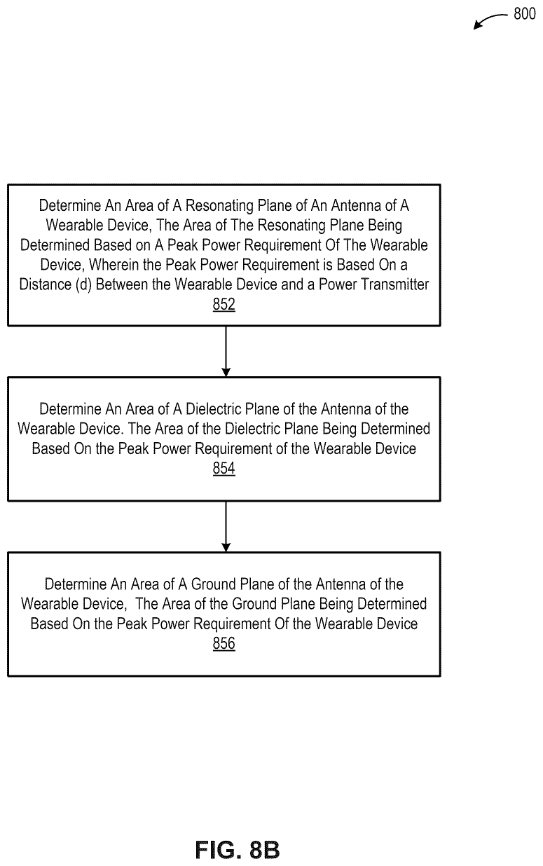

FIG. 8A illustrates a flowchart 800 of example operations according to one embodiment. In particular, the flowchart 800 of FIG. 8B illustrates example operations to determine context-aware rectifier component values for a wearable device. Operations of this embodiment include determining a peak power requirement for a rectifier circuit to be coupled between an antenna and system circuitry of the wearable device, the peak power requirement is based on a distance (d) between the wearable device and a power transmitter 802. Operations also include determining a real value of at least on real circuit component of the rectifier circuit based on the peak power requirement 804. Operations also include determining a reactive value of at least one reactive component of the rectifier circuit based on the peak power requirement 806. In some embodiments, operations also include determining an impedance match for the rectifier circuit to match an impedance of the antenna 808.

To provide radiation patterns fitting the behavioral analysis, as well as to satisfy mechanical and wearability considerations, a planar antenna design is selected. Specifically, a planar inverted-F antenna (PIFA), which encompasses shorting pins, a feed point, and a dielectric insulating layer that separates the ground and a quarter-wave (shorted) resonant patch on the top surface. The device structure shown in FIG. 4d utilizes a digital design and manufacturing process (3D FDM printing) to achieve a customizable PIFA structure with flexible mechanics. The PIFA structure is comprised of multiple layers of conductive and insulating dielectrics embedded into 3D printed thermoplastic polyurethane (TPU) (ETPU=3.3, tan δ=0.09, see Example Methods). The ground plane is comprised of a laser-structured copper-clad polyimide (Pyralux AG185018RY, Dupont) (details in the Example Methods section) and is spaced from the resonating plane with a 3D pillar structure designed to support the resonating plane with minimal dielectric loss while utilizing soft materials that can be structured into almost imperceptible designs. The laser-structured resonating plane is also encapsulated in a top layer of TPU to provide protection during everyday wear. Stretchable curvilinear 3D stretchable connections (C3Cs) link the resonant top patch and ground (FIG. 4d-e). A similar C3C structure is used to guide the feedline of the antenna into the rectifier circuit (FIG. 4e).

Optimization of impedance and mechanics is accomplished with modulation of the serpentine mesh arc angle, defining the ground and radiation plane, and location of C3Cs. Combined with a matched rectifier, a maximum power point (MPP) tailored to operational distance and system load is accomplished. Two antennas are individually optimized for the representative rectifier input impedance values of 1 kΩ and 7 kΩ. The corresponding rectifier performance is shown in FIG. 3f, output voltage and power are simulated at a 50 cm distance from the power casting unit and displayed against system load matching the designed 1 and 7 kΩ (MPP) target. The 7 kΩ matched antenna design provides a higher output power over a broader range with an output of ˜3.4 mW over a range of 5-10 kΩ system load, enabling flexibility in firmware design and current limitation for battery recharge schemes.

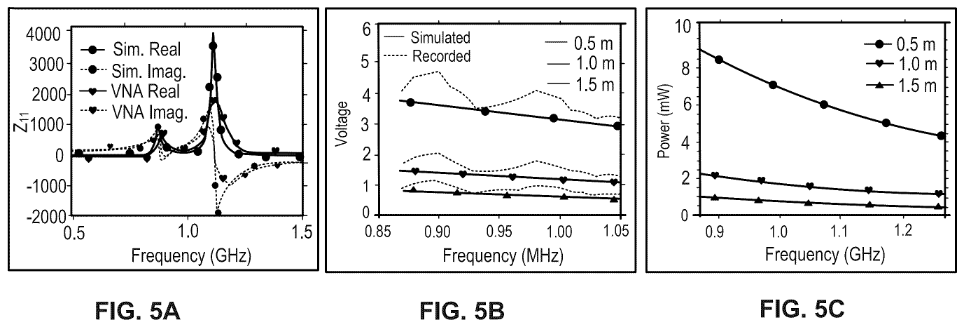

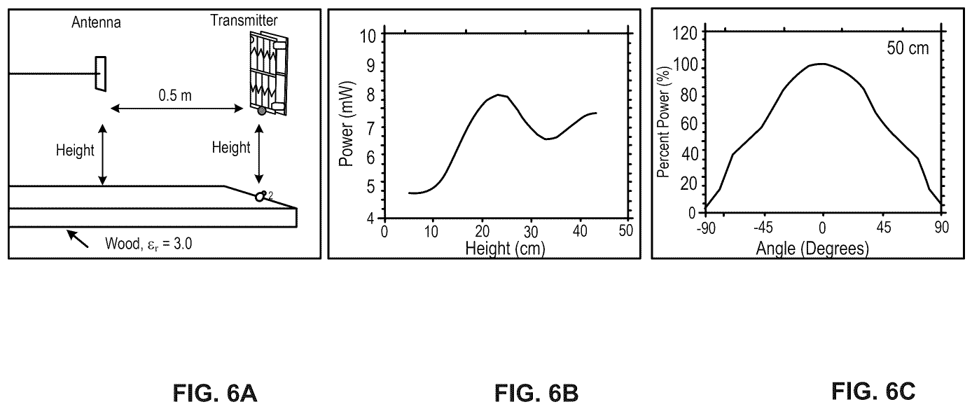

Based on behavioral analysis in FIG. 2c, operation at 40-80 cm from the power casting unit with an estimated system load of 7 kΩ is chosen for optimization. The resulting rectenna performance is shown in FIG. 4g-i, with further details in FIG. 5. FIG. 4g shows load sweep data for the rectenna at 0.5 m from the transmitter. The results measured in an anechoic chamber (Reference) environment achieve a good agreement with the corresponding results simulated in free space. As may be appreciated, application performance can vary depending on environment through variation of casting angle, multipath effects (as illustrated in FIG. 6) or shadowing from the human body (See Example Methods). FIG. 4h shows power output of the device as a function of distance from the transmitter. Similarly, simulations offer a good prediction of performance in the anechoic environment, with performance discrepancies in the application scenario arising from the use of commercially available power casting systems that feature higher gain transmission antennas (see FIG. 6). FIG. 4i shows rotational axis performance of the antenna structure in free space. Variations in performance about the yaw and pitch axis match simulated and recorded data, while corresponding data for the roll axis show discrepancies due to limitations on experimental set up. Results from these experiments show that design choices extracted from system level and behavioral information can be integrated into the digital design process to produce an antenna structure that that can be carefully engineered in a simulated environment to yield rectennas that perform well over a broad range of application environments and scenarios (for example, as illustrated in FIG. 7).

FIG. 8B illustrates a flowchart 850 of example operations according to one embodiment. In particular, the flowchart 850 of FIG. 8B illustrates example operations to determine context-aware antenna values for a wearable device. Operations of this embodiment include determining an area of a resonating plane structure of an antenna of a wearable device, the area of the resonating plane structure being based on a peak power requirement for a rectifier circuit to be coupled between the antenna and system circuitry of the wearable device, the peak power requirement is based on a distance (d) between the wearable device and a power transmitter in communication with the antenna 852. Operations also include determining an area of a ground plane structure, the area of the ground plane structure is based on the peak power requirement 854. Operations also include determining an area of a dielectric layer structure disposed between the resonating plane structure and the ground plane structure, the area of the dielectric layer structure is based on the peak power requirement 856.

### Mechanical Design and Fabrication

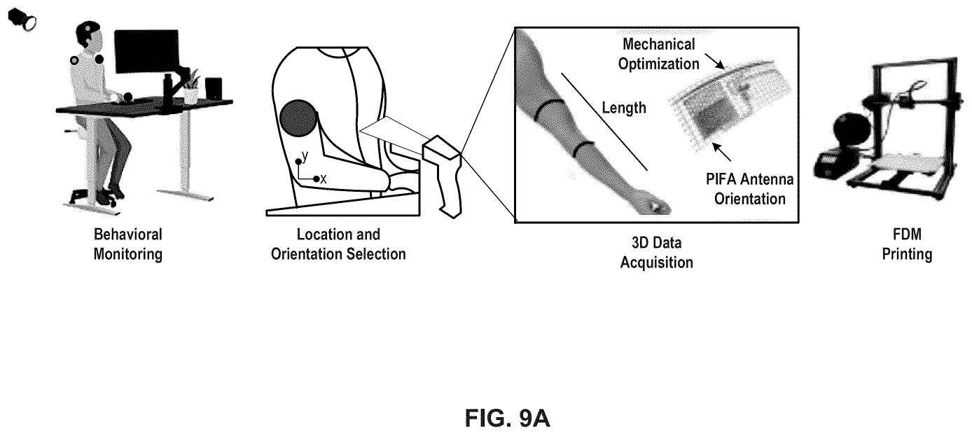

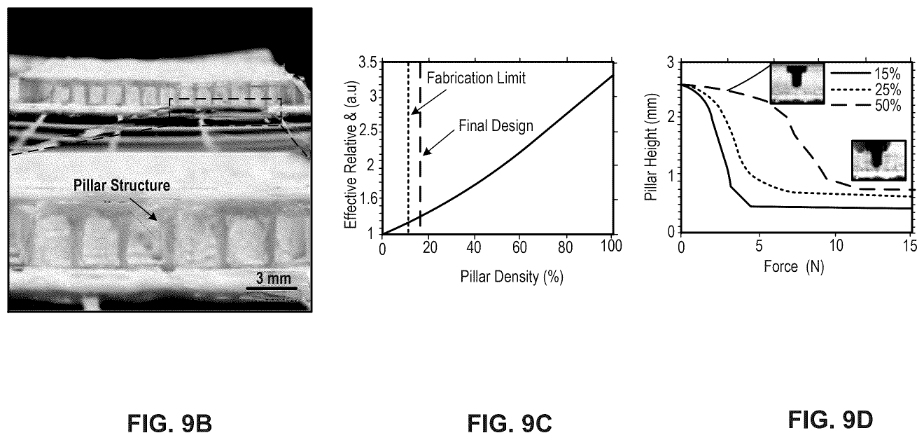

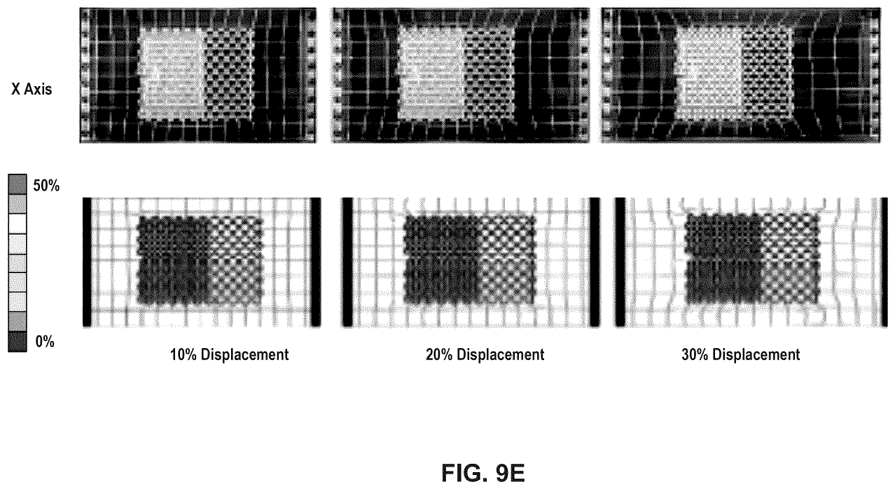

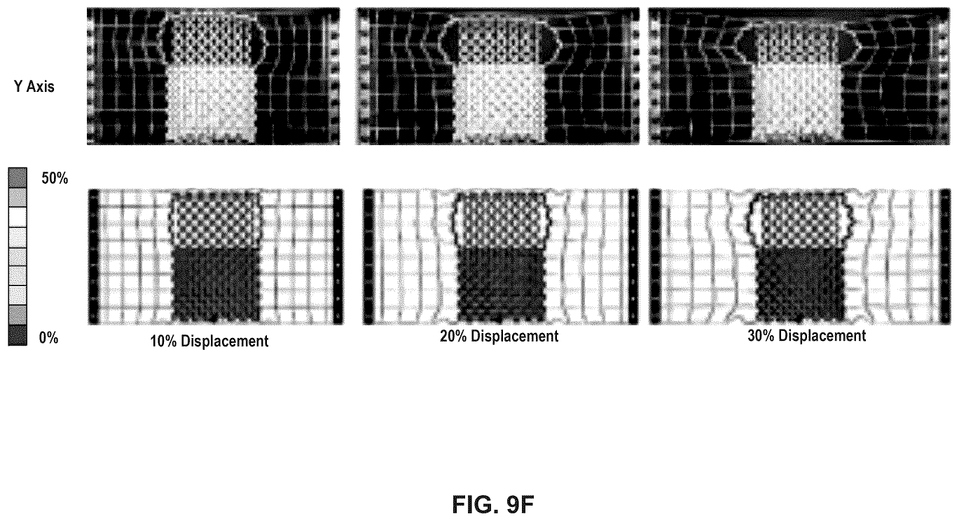

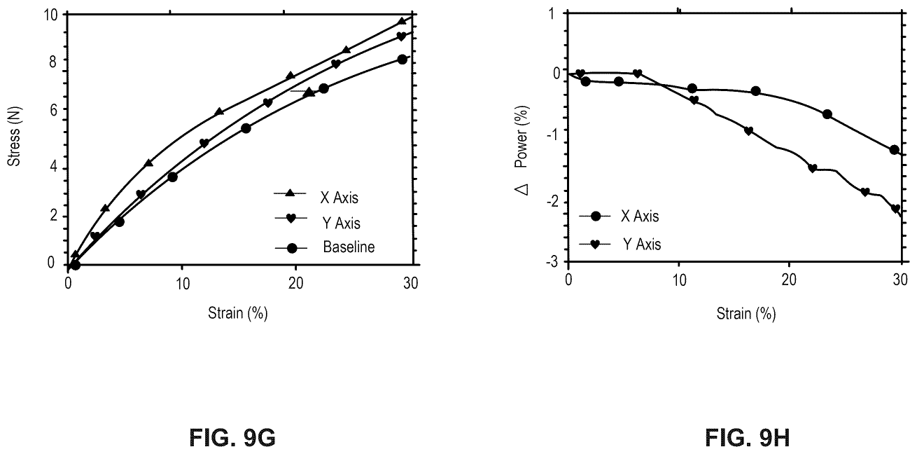

FIG. 9 illustrates mechanical considerations for personalized antenna structures; where FIG. 9a illustrates an example mechanical design process that utilizes behavioral analysis and digital design to form location and mechanical optimization of personalized biosymbiotic devices; FIG. 9b illustrates an example photo of 3D printed pillar structure used to support the resonating plane from the ground plane; FIG. 9c illustrates an example plot of effective permittivity of the insulating layers as a function of 3D printed pillar density; FIG. 9d illustrates an example plot of compression force needed to collapse pillar structure with varying pillar density; FIG. 9e illustrates an example FEA of PIFA embedded into mesh design in a horizontal orientation; FIG. 9f illustrates an example FEA of PIFA embedded into mesh design in a vertical orientation; FIG. 9g illustrates an example stress versus strain curves showing effects of antenna orientation on bulk structure mechanics; and FIG. 9h illustrates an example change in power as a function of strain applied on the system for PIFA embedded in various orientations.

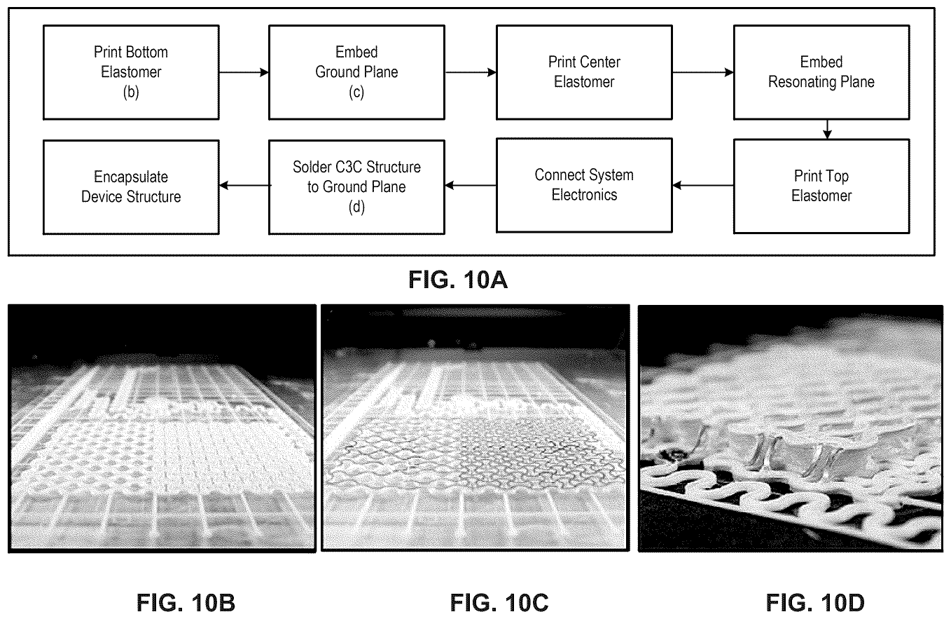

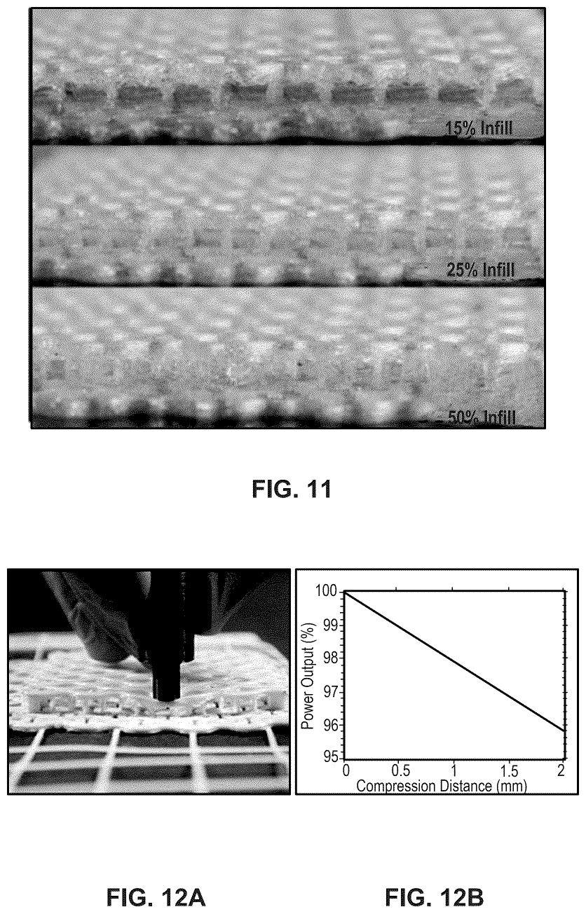

Integration of the 3D printed on-body antenna into a biosymbiotic wearable device is carried out using design strategies and manufacturing schemes previously described, for example, in Stuart et al. The fabrication schemes enable tailoring of electromagnetics and mechanics for context-aware antenna design and allow for precise positioning of the antenna and personalized fit for the wearer. Important considerations are wearability and comfort that enables uninterrupted use over weeks. FIG. 9a details this process, where the personalized PIFA is integrated in biosymbiotic electronics using 3D data from scans of the user. Devices are manufactured using FDM printing with details presented in the Example Methods section and FIG. 10. Key to the realization of the on-body PIFA with relatively lossy TPU, which is incurred to enable mechanical structures that serve overall system performance goals, is the use of 3D printed pillar structures to support the resonating plane of the antenna above the ground plane (see FIG. 9b) with a minimum amount of material. Modulation of pillar density, as seen in FIG. 11, enables complex features that would not be obtainable with conventional fabrication techniques.

The structural makeup of the pillar drives both mechanical and electromagnetic performance of the antenna, with tradeoffs between mechanical stiffness and effective permittivity of the insulating layer. FIG. 9c shows results simulated at 915 MHz for the effective permittivity of the layer separating radiation and ground plane with increasing pillar density. Intuitively, lower pillar density is preferred because of better electromagnetic performance; however, limitations of the fabrication process result in a 10% pillar density limit required for structural integrity. Additionally, mechanical considerations for practical applications limit stiffness and therefore pillar density due to external forces such as compression from clothing, that can cause variation in antenna performance (see FIG. 12). FIG. 4d shows the force required for structural deformation of the antenna with 15, 25, and 50% pillar density over increasing applied force (see Example Methods section). Pillar collapse occurs with as little as 5N, which in turn detunes the antenna resulting in reduced power output. In one example, a pillar density 16% was used, which together with the PIFA antenna is electromagnetically robust and presents a good compromise between antenna performance and robustness in real life scenarios.

In addition to antenna compression, lateral deformation in integrated mesh structures must also be considered in the design and implementation of the final device. FIGS. 9e and 9f show finite-element-analysis (FEA) of mesh structures with embedded PIFAs oriented along the X and Y axis, respectively. In the FEA models, system strain, which is applied to the mesh housing the antenna, is primarily distributed within peripheral linear structure, which yields minor deformation in the antenna structure when strained to 30% displacement. It is important to note limitations of the analysis with large deformation of elastomeric material that result in edge effects seen in FIG. 9f, which may not be present in an integration in a wearable. In either orientation, the placement of the antenna structure demonstrates minimal effect on the mechanical properties of the system (as shown in FIG. 9g). Minor deformations in the ground plane result in minimal effect on electromagnetic properties, as shown in FIG. 9h. In the most extreme case, power output of the antenna is reduced by 2.3%. The scenarios covered in this figure demonstrate the worst-case scenario for wearable applications such as placement on highly mobile locations such as the elbow (30% strain).

### System Configuration and Sensing Performance

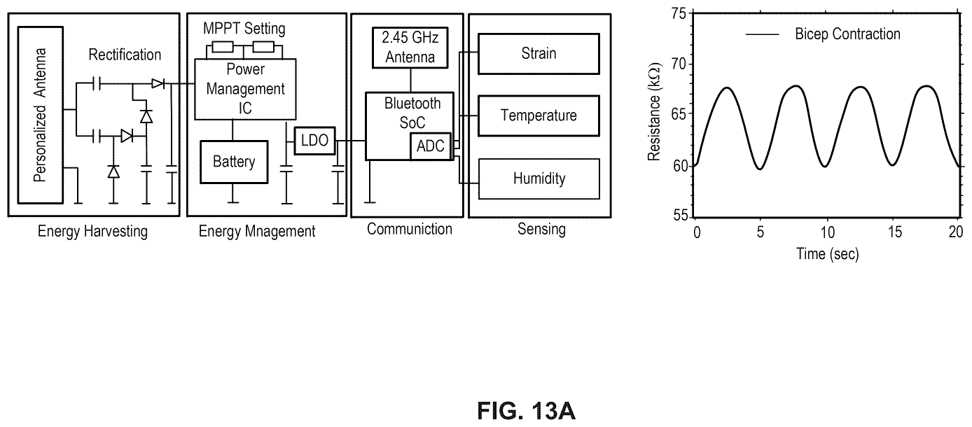

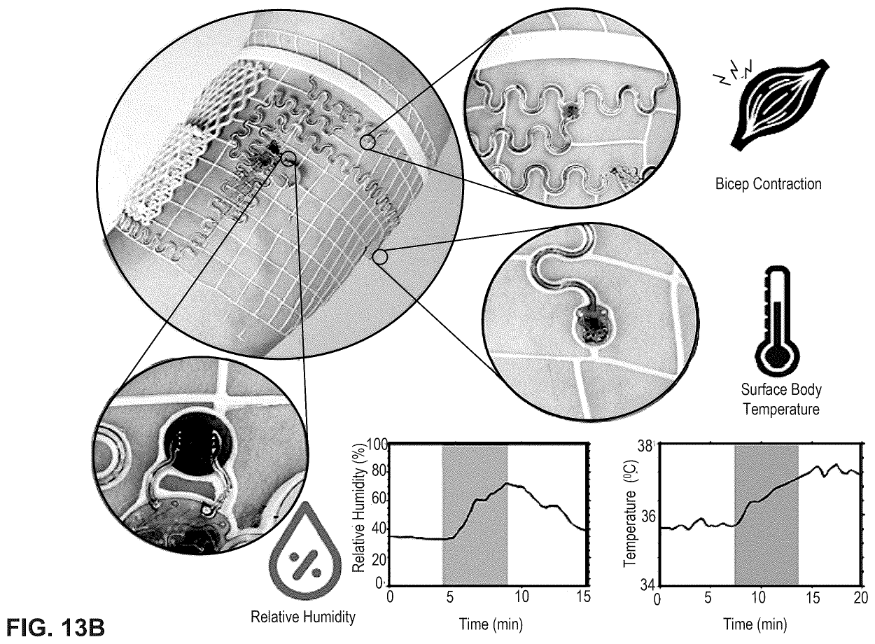

FIG. 13 illustrates an example biosymbiotic device design and function that includes example illustrations of a simplified electronic circuit schematic (FIG. 13A), biosymbiotic device composition with sensor placement and characteristic performance graphs (FIG. 13B).

With concepts described herein, significant power transfer to the wearable is expected, enabling continuous operation and multimodal high-fidelity recording of biosignals. To demonstrate this capability, a system with BLE SoC, multimodal sensors, context-aware antenna designs, and soft mechanics is created. FIG. 13A shows device composition, simplified electrical schematic, image of the device located on the proximal region of the upper arm (FIG. 13B), and images of sensing nodes with corresponding characteristic performance graphs (FIG. 13B). The device features the PIFA and associated rectifiers introduced in FIG. 4. Power from the rectification circuit is sent to a power management IC, which includes maximum power point tracking (MPPT) control. A small (9 mm×9 mm) battery (25 mAh) is used to provide power to the device during operation outside of the power casting area. A BLE SoC controls peripheral sensors and relays collected data via a 2.45 GHz antenna (see Example Methods section). This device hosts multimodal sensing capabilities including a sub millikelvin resolution temperature sensor, a 3D-printed circumferential strain gauge, and a relative humidity sensor. Each sensor utilizes commercially available components integrated on rigid islands of no more than 6 mm in diameter to enable system level soft mechanics and is connected using serpentine interconnects placed at physiologically relevant locations extracted from the 3D data (FIG. 9a).

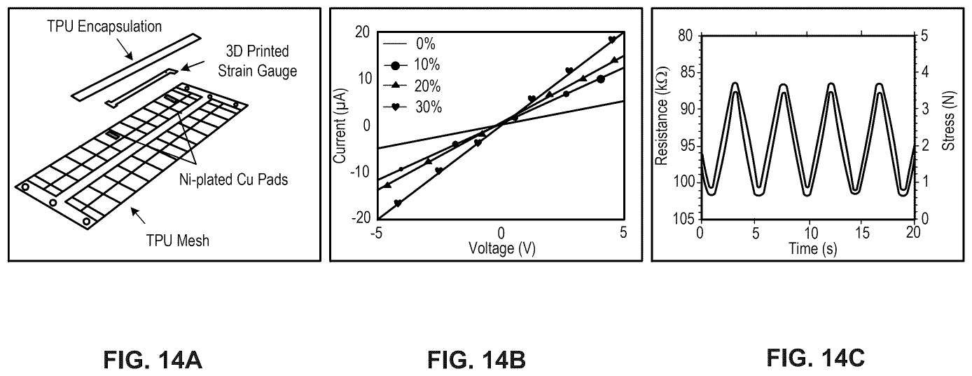

Sensor performance, which benefits from conformal and circumferential attachment to the body is characterized with simple experiments. In the graphs shown in FIG. 13, shaded area shows biceps contraction, exercise induced temperature and humidity changes with characteristic performance of muscle strain sensors (7.14×10-4 % Strain/Ω), thermography sensors (2.12 K/V) and skin humidity (33.9 % RH/V), with additional details described in the Example Methods section and FIGS. 14, 15 and 16.

### Chronic Data Acquisition Without the Need for User Interaction

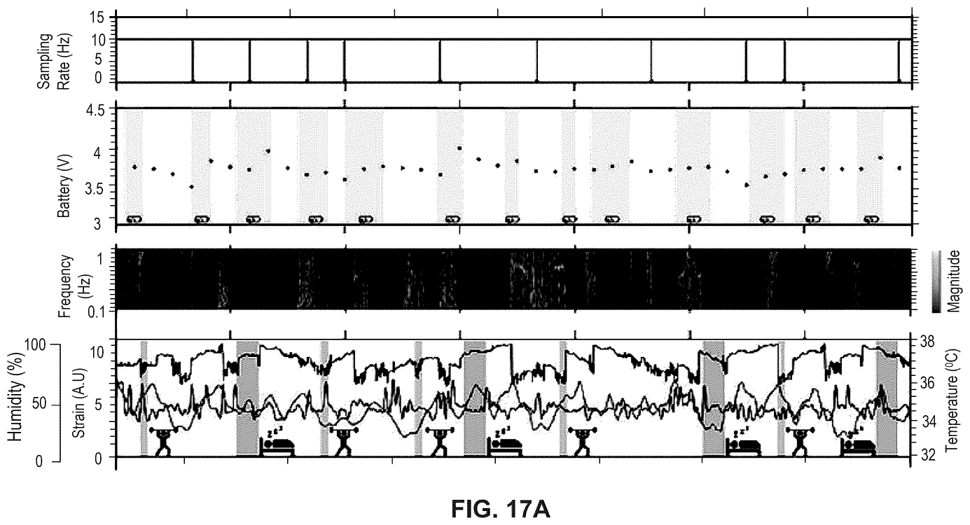

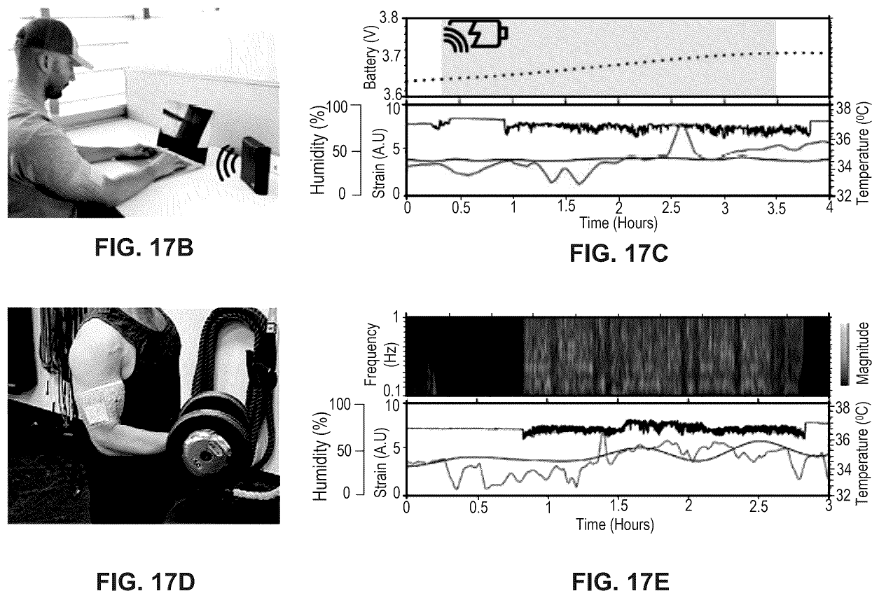

FIG. 17 illustrates an example long-term system demonstration and performance; where FIG. 17a illustrates an example data collected from 14-day experiment showing collection of sampling rate (top graph), battery voltage (middle graph), temperature, humidity, strain, and corresponding continuous wavelet transform; FIG. 17b illustrates an example image of device operation in an office setting; FIG. 17c illustrates an example plot of 4 hours of data collected during office occupancy, showing passive battery recharge over time with continuously collection of temperature, humidity, and strain; FIG. 17d illustrates an example image of device operation during exercise in a gym setting; and FIG. 17e illustrates an example plot of 2 hours of collected data during gym exercise showing temperature, humidity, and strain with corresponding continuous wavelet transform of 3D printed strain gauge data.

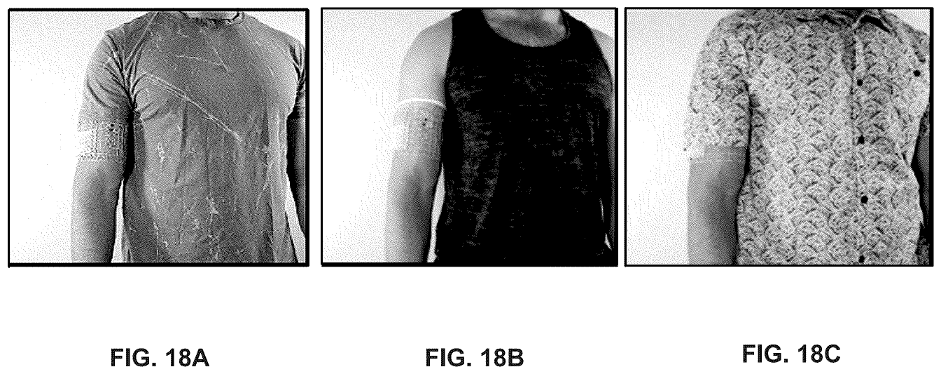

To demonstrate chronic, uninterrupted operation capabilities of the device a 14-day experiment is performed. The device was deployed on the proximal region of the bicep for imperceptible use with several types of daily outfits (see FIG. 18). Data is summarized in FIG. 17a showing continuously captured raw data over 2 weeks. During the test, the device is only recharged when in proximity of a power caster located at the work location on the desk, as outlined in the behavioral analysis section. Battery voltage is monitored at regular intervals, with regions shaded indicating proximity to a power casting unit. Recorded battery voltage never falls below 3.49 V during the experiment, demonstrating robust operation without reliance on human interaction for recharging. Operation with a constant sensing duty cycle of 10 Hz is constant throughout the entirety of the test with only 10 instances of data drop out (indicated with a dot) over 2 weeks of operation. Strain data is visualized in the frequency domain using a continuous wavelet transform to show periods of increased bicep contraction frequency, matching periods of physical exercise (shaded). Similarly, incidences of increased activity overlap with increases in humidity, showing the capability to monitor perspiration.

Device usage in a typical office setting is shown in FIG. 17b with transmitter located approximately 50 cm from the device. The corresponding data shown in FIG. 17 c highlights a charging period where battery voltage is increased by 100 mV in˜3 h at the desk corresponding to a charge rate of 2.2 mW (average system power consumption of 2.15 mW, resulting in 4.35 mW of average power transfer to the wearable). FIG. 17d shows device operation in a gym setting with the subject performing a bicep curl. Corresponding data displayed in FIG. 17e shows 2 hours of data before, during, and after the training session, demonstrating the capability to record high-fidelity biosignals in highly air-conditioned environments with high amount of air movement. In this graph, a steady increase in body temperature is observed during the period of activity, correlating with an increase in localized humidity. Additionally, continuous activity of bicep strain is observed (6 contractions/min), with periods of increased frequency (50 contractions/min) denoting exercises that specifically target that muscle group.

### Discussion

Development of wearable devices intended for continuous recording on the body such as digital medicine applications still grapple with user acceptance and face many technological hurdles that impede performance, impacting their use as diagnostic and therapeutic tools. One of the most challenging aspects is user retention of wearable devices, which only have an average use time of 12 months. Imperceptible devices that eliminate recharging and interaction requirements with wearable technologies are core to advance digital medicine applications.

Accomplishing advances electromagnetically and mechanically is highly complex because performance gains in one area likely impact others. Critical is balanced system level performance to enable operation over weeks and months without impacting daily activities. The framework introduced here using behavioral analysis and digital manufacturing techniques to enable context-aware antenna and rectifier designs to optimize power transfer with an on-body antenna to enable indefinite device operation. The resulting system level insight provides a performance envelope that takes electromagnetic, mechanical, and sensing performance into account to deliver a balanced data-driven design approach with context-aware solutions to enable indefinitely operating wearables.

Deployment of these design strategies for on-body antennas also introduces a methodology to assist in development of antennas, rectifiers and systems for wireless devices that is transferrable to contexts other than wearables and applies to many scenarios that involve technologies used in proximity or by human subjects. For example, context-aware designs can aid WPT design for human interfaces such as wireless mice, keyboards, game controllers, headphones etc. and other wearables such as wrist mounted fitness devices.

### EXAMPLE METHODS

### Antenna Fabrication

Pyralux double-sided copper-clad laminate (AG185010RY; constituent layers, 18 μm copper, 50 μm polyimide, and 18 μm copper) served as the conductor substrate for electronic fabrication. Antenna structures were constructed using a UV laser ablation system (LPKF; Protolaser U4). After structuring, material was cleaned by sonication (Vevor; commercial ultrasonic cleaner 2L) for 2 minutes in flux (Superior Flux and Manufacturing Company; Superior #71) and 1 minute in isopropanol (Mg Chemicals) with a subsequent rinse in deionized water to remove organic byproducts from the ablation process. Complementary 3D printed structures were generated using CAD software (Autodesk; Fusion 360) and imported into a 3D slicing software (Prusa3D; PrusaSlicer) for printing. A fusion deposition modeling (FDM) printer (Creality; CR-10S) was outfitted with a direct drive extruder (Diabase Engineering; Flexion) and automatic bed leveling unit (Antclabs; BLTouch). A Thermoplastic polyurethane filament (NinjaTek; NinjaFlex) was printed at 45 mm/s and 225° C. with a bed temperature of 45° C. The printer was paused at various heights to allow for insertion of Pyralux material using a channel structure to guide electronics placement. After printing, the shorting straps of resonating plane of the antenna was attached to the ground plane and the antenna feed was attached to the rectifier circuit using a soldering iron.

### Circuit Design and Fabrication

Commercially available components were placed by hand and reflowed with low-temperature solder paste (Chip Quik; TS391LT). A Dickson voltage rectifier was comprised of 0402 high frequency capacitors (American Technical Ceramics; 600L8R2CT200T) and 0201 diodes (Infineon; BAT2402LSE6327XTSA1). Rectified power was sent to a power management IC (Analog Devices; ADP5090ACPZ-1-R7) which controlled recharging of a small lithium polymer battery (400909) and managed maximum power point tracking (MPPT). A 3.3 V low-dropout (LDO) regulator was used to stabilize voltage to the peripheral sensors and BLE SoC (Dialog Semiconductor; DA14585). The BLE SoC was programed using Dialog's SmartSnippet Studio with a custom programming board which accepted programming tabs on the board with a flexible circuit connector.

### Mechanical Characterization

Mechanical characterization of mesh and antenna structures were carried out using a custom 3D printed stretching stage. Mesh structures with embedded antennas utilized a uniform linear pattern with total device length of 175 mm and varying antenna orientation. Each design was affixed to the stretching stage using M3 screws. The stretching stage used a 5 kg load cell (Degraw; 050HX) and load cell simplifier (SparkFun; HX711) to monitor bulk strain profiles during displacement. A 915 MHz transmitter (Powercast; TX91503) was placed at 50 cm from the stretching stage using a tripod. The stage was moved using Pronterface while power and stress data was recorded using a microcontroller (Arduino; ATmega2560).

### TPU Permittivity Measurements

Relative permittivity and loss tangent of the NinjaFlex filament material were measured using a dielectric probe kit (SPEAG; DAK-3.5) and a vector network analyzer. These measurements were performed on TPU samples with size of 50 mm×50 mm and thickness of 20 mm. The samples were 3D-printed with maximum density, i.e., at nominal 100% infill ratio. Calibration of the measurement apparatus was performed using open and shorted probes, as well as a measurement in distilled water to provide a reference with a well-characterized material.

### Mechanical and Electromagnetic Finite Element Analysis

Mechanical finite element analysis (FEA) was carried out using simulation software (Ansys Mechanical 2019). 3D object files representing device structures were imported into the static structural analysis tool for displacement and strain analysis. Constituents of the device structure, including copper, polyimide and TPU were assigned the following material properties (Copper: Young's Modulus=1.1×105 MPa; Density=8930 kgm-3; Poisson's Ratio=0.343; Tensile Ultimate Strength=210 MPa. Polyimide: Young's Modulus=2500 MPa; Density=1540 kgm-3; Poisson's Ratio=0.0.34; Tensile Ultimate Strength=96.3 MPa. TPU: Young's Modulus=12 MPa; Density=1040 kgm-3; Poisson's Ratio=0.48; Tensile Ultimate Strength=26 MPa). Fixed supports were used on one side of the design to simulate fixed integration with the benchtop stretching stage. The opposite end of the devices was then increased incrementally with simulation results showing both stress and strain profiles of the resulting structure. The strained structure was then exported and simulated through electromagnetic simulation software (Ansys HFSS 2019) to show effects of mechanical strain on EM performance.

### Behavioral Analysis

A Raspberry Pi (Raspberry Pi; 4 Model B) was functionalized with a Raspberry Pi HQ camera module mounted onto a portable tripod (Sumolink). A 2.8-12 mm varifocal lens (Arducam) was attached to provide a wide-angle view. Custom python script was used to collect and store images every 20 seconds onto an external hard drive. Images were collected from the hard drive and imported into MATLAB (2022a) where they were stitched together to create a 30-fps video. Videos created from this process were fed into DeepLabCut (version 2.2.b6) to perform deep neural network analysis of human motion and behavior. A neural net was trained for each participant by tracking key features of the body, including health, shoulder, and hand location. Training was performed with a high-performance computer (University of Arizona; HPC) with 100,000 iterations. The results of tracking were extracted in spreadsheet format containing both x and y location coordinates for tracked objects, as well as confidence values for each data point. Data points with confidence values of 99% or greater were imported into MATLAB and processed for extraction of key characteristic data including distance to the transmitter, angle of offset between shoulders, and angle of the device structure to the transmitter.

### Free-space Far-field Performance Characterization

To estimate the received power level PPrr at distances dd away from the transmitter (Powercast; TX91503), the Friis Transmission Equation PPrr=PPttGGttGGrr□λλ4ππππ□2 was used, where PPttGGtt=3 Watt is the equivalent isotopically radiated power (EIRP) of the transmitter, GGrr is the unity gain of an ideal isotropic antenna (0 dBi) and λλ is the wavelength at 915 MHz.

### Electromagnetic Performance Simulation in Radiative Near Field

An investigation of the power density levels as a function of the distance from the power-casting transmitter was completed in CST Studio Suite 2021. This investigation aimed at compensating the prediction error of power levels in the radiative near field of the power caster arising when using the Friis Transmission Equation where far-field condition is implied. A transmitting antenna with performance similar to a power caster (Powercast; TX91503) with EIRP of 3 Watt was reproduced in the simulation. Integration planes with the effective area GGrr□λλ4ππ□2 of an ideal isotropic antenna (GGrr=0 dBi) were built and placed away from the power caster, from 0.2 m to 1.2 m with a step of 0.1 m. Power density was computed by integrating Poynting Vectors over these integration planes individually.

### Application Scenario Performance Characterization

To measure free space rectenna performance in a typical application setting (office space), the rectenna was attached to a 3D-printed Polylactic Acid (PLA) apparatus that allowed for positional and angular manipulation of rectenna. The power casting unit was placed on a wooden table to mimic a typical office setting and short wires were used to attach the rectenna to a multimeter (AstroAI, DT132A). Various resistors were used to mimic system loads while the voltage output was measured at varying distances from the transmitter, as well as at different rotational positions along the principal axes. For on body measurements, the rectenna was attached to the proximal region of the forearm with similar recording infrastructure.

For experiments with the commercially available and FCC-approved power caster, the power density and the receiver antenna gain differ resulting in slightly higher performance in the office environment as shown in FIG. 3g and h. The discrepancies between the indoor office environment and the anechoic chamber environment are principally caused by multi-pathing due to the reflection and diffraction. The full-wave electromagnetic simulations in FIG. 6a illustrate the power density oscillation phenomenon with respect to the measurement setup heights to the test bench. In addition receiver antenna gain affected by the surrounding objects also determines the output power in a WPT system.

### Device Electrical Characterization

Current consumption of the device was recorded using a benchtop battery supply (3.3 V) and a current meter (LowPowerLab; CurrentRanger) with an internal shunt resistor of 10 Q. Device functionality was modulated over BLE using a smartphone and data was acquired in real time using an oscilloscope (Siglent; SDS1202X-E).

### Antenna Compression Testing

To test effects of compression on the rectenna performance, a rectenna was designed and fabricated according to behavioral patterns extracted in FIG. 2. The rectenna was placed on a scale (1 kg; Kubei) and zeroed. The rectenna was compressed at a single serpentine using a 3D printed device with an effective area of 19.63cm2 . The rectenna was compressed with simultaneous image collection, noting the compressive force experienced by the scale. Images were examined in ImageJ to determine distance of compression between the ground and resonating place and correlated to force measured with the scale.

### Temperature Sensor Fabrication and Characterization

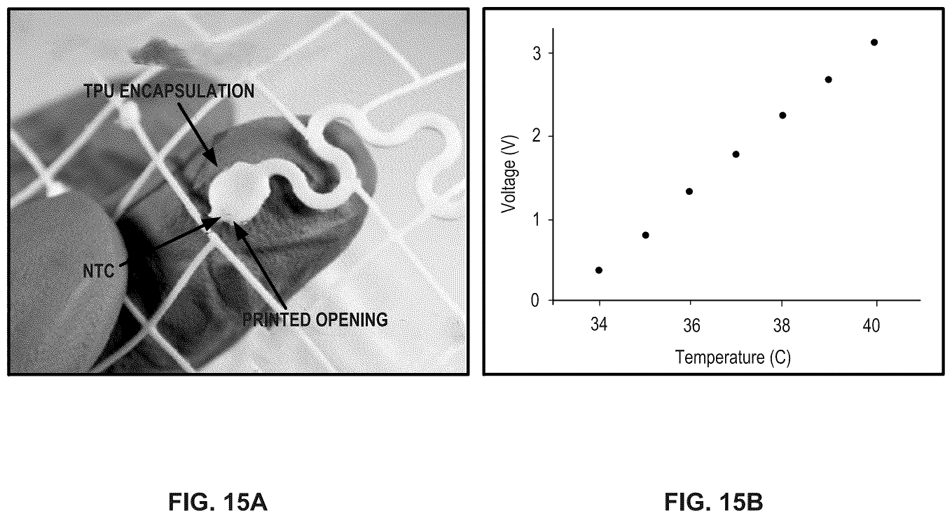

A 100 kΩ NTC thermistor (TDK Corporation, NTCG064EF104FTBX) was placed on the back side of a flexible PCB (3 mm in diameter) balanced using a wheat stone bridge with a 69 kΩ resistor to provide a reference voltage of 0.116 V. The bridge was fed into a differential amplifier (Analog Devices, ADA 4505-1) with gain set to 82.64X using a 10 MΩ and a 121 kΩ resistors. A small opening was designed in the mesh structure to allow for placement of the NTC in proximity with the skin (see FIG. 15). The NTC was then encapsulated with a thin layer of ultraviolet (UV)-cured epoxy (3DMaterials; SuperFlex) to prevent ingress of sweat while maintaining low thermal mass. Characterization of temperature sensor was carried out using a proportional-integral-derivative controlled hot plate. The custom temperature sensor node was attached to the surface of the build plate next to a commercial thermistor probe. The system was then covered with insulating material to prevent convection heating and cooling effects. Temperature was increased in 0.25° C. increments and left for 2 min for the temperature to stabilize. Once stable, the ADC readout was recorded, as well as the commercial thermistor readings. ADC values were converted to voltage, and a standardized curve was developed.

### Strain Gauge Fabrication and Characterization

Strain gauges were digitally designed using 3D computer-aided design software (Autodesk; Fusion 360). Stereolithography files were generated from the 3D model and imported into a 3D slicing software (Prusa3D; PrusSlicer) for generation of machine code. A fusion deposition modeling printer (Creality; CR-10s), outfitted with custom x-axis carriage housing a direct drive extruder (Diabase Engineering; Flexion) was utilized for 3D printing. A conductive thermoplastic polyurethane filament (NinjaTek; Eel) was printed at 30 mm/s and 225° C. with a bed temperature of 45° C. 3D printed strain gauges were then embedded into the device structure using a 3D printed channel. Copper-clad Pyralux sheets were cut into tabs using a UV laser ablation system and subsequently nickel platted. Nickel platted tabs were placed into the channel using a glue stick to provide adhesion to the TPU. The printed strain gauge was then placed into the channel over the capper strips before resuming the print and covering the channel with NinjaFlex TPU (see Supplementary FIG. 7). To characterize the resistive properties of the 3D printed strain gauge, current versus voltage plots were collected using a source measurement unit (Keithly; 2450 SourceMeter) and a custom, 3D-printed stretching stage. The strain gauge device was affixed to the stretching stage and connected to the SMU with wire leads. The SMU varied voltage into the strain gauge from- 5 to 5 V in 100 mV increments, while concurrently measuring the current draw from the system. This test was repeated at 0, 10%, 20%, and 30% displacement.

### Humidity Sensor Fabrication and Characterization

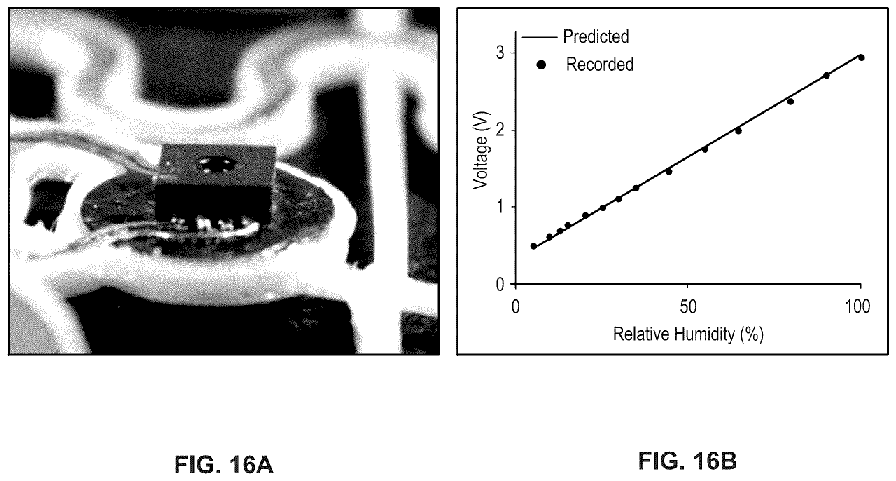

A commercially available humidity sensor (Sensirion; SHT30) was utilized for analog recording of local relative humidity. IC was placed on the back side of a flexible PCB and attached to the top side of a 3D printed structure to allow for proximity to the skin (see FIG. 16). Analog readings were collected with the BLE SoC's on-board ADC. To characterize the sensor performance, the device was placed in a dehydrator (Presto; 06300 Electric Dehydrator) alongside a commercially available relative humidity sensor (Mengshen; M86). The devices were left in the dehydrator until the relative humidity reading reached a steady state. The output voltage was recorded, and the dehydrator was turned off, allowing for the ingress of humidity into the system. Periodic recording of output voltage and complementary relative humidity measurements were taken to monitor increase in humidity. Once the system had reached steady state, a spray bottle with water was used to increase the localized humidity beyond environmental limitations.

### Long-term Data Collection

A biosymbiotic device, as descried in FIG. 13, was designed for application to the proximal region of the arm with integrated 3D-printed strain gauge oriented along the anterior-posterior axis, a sub millikelvin resolution temperature sensor placed in the axilla region, and a localized relative humidity sensor place on the lateral portion of the arm. The device was outfitted with a 25 mAh battery (EHAO; 400909). Power casters (Powercast; TX91503) were placed in key locations identified as frequent destinations with high levels of occupancy. Data aggregation was carried out with using a miniaturized computer (Raspberry Pi; Raspberry Pi model B) with a 15000 mAh power bank (Miady; HYD007) and custom software to collect and log a data into .csv file format. Daily activity, including sleep, exercise, and time in front of a power casting unit was recorded in a journal. This device hosts multimodality sensing capabilities including a sub millikelvin resolution temperature sensor, 3D-printed strain gauge, and relative humidity sensor. To show the efficacy of this system, a strain gauge was applied to the proximal bicep and the subject was asked to perform a series of control bicep curls with a 25 lbs weight. The temperature sensor is placed in the axilla region of the body to provide a close analog to core body temperature. The sensor is comprised of a negative temperature coefficient (NTC) thermistor with a Wheatstone bridge in direct contact with the skin with low thermal mass to extract subtle changes in temperature (FIG. 15). Standardized testing uses a subject on a stationary bike at moderate intensity for 5 minutes and subsequent rest. Increase in body temperature is clearly observed during activity, which induces a 1.5° C. change in body temperature that persists after exercise has ended. Because of the proximity to the body, small changes in localized humidity can be detected before sweating occurs.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method for context-aware antenna design for a wearable device, comprising:
determining an area of a resonating plane structure of an antenna of a wearable device, the area of the resonating plane structure being based on a peak power at a selected system voltage requirement for a rectifier circuit to be coupled between the antenna and system circuitry of the wearable device, the peak power requirement is based on a distance (d) between the wearable device and a power transmitter in communication with the antenna;
determining an area of a ground plane structure, the area of the ground plane structure is based on the peak power requirement; and
determining an area of a dielectric layer structure disposed between the resonating plane structure and the ground plane structure, the area of the dielectric layer structure is based on the peak power requirement.

14. The method of claim 13, wherein the distance (d) includes an average of the distance of wearable device, worn by a plurality of test subjects over a selected time period (t) during a selected activity, from the power transmitter.

15. (canceled)

16. (canceled)

17. (canceled)

18. The method of claim 13, wherein the area of the resonating plane structure, ground plane structure and dielectric layer structure are also based on an angle (theta) between the wearable deice and the power transmitter with respect to a reference plane.

19. The method of claim 18, wherein the angle (theta) includes an average of angles between the wearable device, worn by a plurality of test subjects over a selected time period (t) during a selected activity, and the power transmitter.

20. The method of claim 13, further comprising determining a dielectric constant of the dielectric layer structure based on the peak power requirement.

21. The method of claim 18, wherein the resonating plane structure comprises a serpentine material comprising a plurality of arcuate segments, and wherein the method further comprises determining an arc angle of at least one arcuate segment is based on the angle (theta).

22. The method of claim 13, further comprising determining a shielding strength of the ground plane structure based on the peak power requirement.

23. The method of claim 13, wherein the antenna is a planar antenna.

24. The method of claim 13, wherein the antenna is a planar inverted F antenna (PIFA).

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. An antenna for a wearable device, comprising:
a resonating plane structure, an area of the resonating plane structure being based on a peak power requirement for a rectifier circuit to be coupled between the antenna and system circuitry of the wearable device, the peak power requirement is based on a distance (d) between the wearable device and a power transmitter in communication with the antenna;
a ground plane structure, the area of the ground plane structure is based on the peak power requirement; and
a dielectric layer structure disposed between the resonating plane structure and the ground plane structure, the area of the dielectric layer structure is based on the peak power requirement.

38. The antenna of claim 37, wherein the distance (d) includes an average of the distance of wearable device, worn by a plurality of test subjects over a selected time period (t) during a selected activity, from the power transmitter.

39. (canceled)

40. (canceled)

41. (canceled)

42. The antenna of claim 37, wherein the area of the resonating plane structure, ground plane structure and dielectric layer structure are also based on an angle (theta) between the wearable deice and the power transmitter with respect to a reference plane.

43. The antenna of claim 42, wherein the angle (theta) includes an average of angles between the wearable device, worn by a plurality of test subjects over a selected time period (t) during a selected activity, and the power transmitter.

44. The antenna of claim 37, wherein a dielectric constant of the dielectric layer structure based on the peak power requirement.

45. The antenna of claim 43, wherein the resonating plane structure comprises a serpentine material comprising a plurality of arcuate segments, and wherein an arc angle of at least one arcuate segment is based on the angle (theta).

46. The antenna of claim 37, wherein a shielding strength of the ground plane structure based on the peak power requirement.

47. The antenna of claim 37, wherein the antenna is a planar antenna.

48. The antenna of claim 37, wherein the antenna is a planar inverted F antenna (PIFA).
